(19) United States
(12) Patent Application Publication
(10) Pub. No.: US 2004/0226962 A1
(43) Pub. Date: Nov. 18, 2004

(54) Automatic liquid dispenser

(76) Inventors: Richard Mazursky, Riverwoods, IL (US); David Waskin, Niles, IL (US)

Correspondence Address: MICHAEL BEST & FRIEDRICH LLC, 401 NORTH MICHIGAN AVENUE, SUITE 1900, CHICAGO, IL, 60611-4212, US

(21) Appl. No.: 10/638,513

(22) Filed: Aug. 11, 2003

Related U.S. Application Data
(60) Provisional application No. 60/470,786, filed on May 15, 2003.

(51) Int. Cl. B67D 5/08

(52) U.S. Cl. 222/95; 222/105; 222/64; 222/52; 222/108; 222/333; 222/325

(57) ABSTRACT

A free-standing or wall-mounted dispenser and system for automatically dispensing liquid, includes a base, which may be shaped so that the dispenser remains free of dispensed liquid, and may include a removable tray to catch accidentally or residually dispensed liquid. The dispenser generates an infrared signal in the proximity of the dispenser's spigot. A user's hand, or other object, intersects the infrared signal and causes the unit to dispense liquid. The dispenser accepts a DC power source, and includes an on-off switch, which can be switched off for refilling, moving or cleaning the dispenser, and prolonging battery life. A disposable liquid cartridge in the form of a bag or bottle with a valve can be incorporated into the system, together with a master switch disabling the dispenser until an acceptable keyed cartridge is properly inserted.

### CROSS-REFERENCE TO RELATED PATENT APPLICATIONS

This patent application claims the benefit of U.S. Provisional Patent Application No. 60/470,786, filed May 15, 2003.

### FIELD OF THE INVENTION

The invention relates to devices for dispensing liquid soap and other viscous materials. More particularly, the present invention relates to devices that automatically dispense a quantity of liquid soap or other liquid upon sensing the presence of a user's hand or other object.

### BACKGROUND OF THE INVENTION

Devices for dispensing fluids are well known, and have been used to dispense liquid soaps, lotions, and cleaning fluids for many years. While capable of dispensing any viscous fluid, the present invention is primarily concerned with dispensing liquid soap, hand or body lotions or other liquids.

Most dispensers for liquid soap are manually operated, meaning that a user must press a button or lever. The handling of the dispenser can serve as a vehicle for transmission of bacterial or other contamination to the user. Since it is unsanitary to handle the dispenser, it would be desirable to obtain soap without touching the dispenser. Also, the dispenser may often become unsightly and difficult to clean because liquid drips on the exterior housing or adjoining surfaces.

Automatic wall-mounted dispensers are widely used in public facilities, but are disadvantageous for private household use. Such dispensers are unsightly, large, permanently installed fixtures with a commercial AC power source. As wall-mounted dispensers are not easily adapted to home use, a need exists for an economical, compact, transportable, automatic dispenser that efficiently operates from battery power.

### BRIEF SUMMARY OF THE INVENTION

The invention provides a system for dispensing liquid soap or other liquids. The dispenser includes a molded base and cover comprising a housing which contains: a reservoir to hold liquid, at least one discharge opening in the reservoir, a pump, a motor for driving the pump, a switch for actuating the motor, a DC power source, and detection circuitry which precludes the need for the user to touch the dispenser. The dispenser preferably will have an on-off switch that can be used when refilling or moving the dispenser, cleaning it, or when the dispenser is not used for extended periods of time. The on-off switch can assist in extending the battery life.

A preferred embodiment of the invention comprises a compact housing with a shaped base that accepts a removable tray for catching and retaining accidentally or residually dispensed liquid. The dispenser can be placed on a countertop or wall mounted. The dispenser is battery powered, energy efficient, and can operate many times before replacing the battery. The dispenser operates by generating an infrared signal in the proximity of the dispenser's spigot. A user's hand or other object reflects the infrared signal back to the housing where it is received and causes the unit to turn on and dispense liquid. The dispenser may include one or more signals that will indicate low battery, when the dispenser is in use, or time to refill.

Additional embodiments of the invention include a disposable liquid soap cartridge. The disposable soap cartridge can be in the form of a bag, bottle, or other container with a resealable valve. The cartridge includes an integrated key which can be incorporated into the cap, neck, or reservoir of the cartridge. The dispenser has a switch that disables the dispenser until an acceptable keyed cartridge is properly inserted.

### BRIEF DESCRIPTION OF THE DRAWINGS

The present invention is described with reference to the accompanying figures, which illustrate embodiments of the present invention. However, it should be noted that the invention as disclosed in the accompanying figures is illustrated by way of example only.

FIG. 1 is a front view of an automatic liquid dispenser.

FIG. 2 is a side view of the embodiment of FIG. 1, showing the interior arrangement of functional elements in dotted lines.

FIG. 3 is a top view of the embodiment of FIG. 1, showing the interior arrangement of functional elements in dotted lines.

FIG. 4 is a back view of the embodiment of FIG. 1, showing the interior arrangement of functional elements in dotted lines.

FIG. 5 is a second embodiment of an automatic liquid dispenser that accepts a disposable drop-in liquid cartridge.

FIG. 6 is a view of the underside of the top lid of the embodiment of FIG. 5, showing cartridge retaining features.

FIG. 7 is a view of the disposable drop-in liquid cartridge of the embodiment of FIG. 5.

FIG. 8 is a third embodiment of an automatic liquid dispenser that accepts a disposable liquid bottle.

FIG. 9 is a side view of the disposable liquid bottle of the embodiment of FIG. 8.

FIG. 10 is an end view of the disposable liquid bottle of the embodiment of FIG. 8, showing the cap.

FIG. 11 is a section view of a disposable liquid bottle and dispenser housing of the embodiment of FIG. 8, showing activation of the dispenser by a bottle projection.

FIG. 12 is a section view of a disposable liquid bottle and dispenser housing of the embodiment of FIG. 8, showing activation of the dispenser by a bottle recess.

### DETAILED DESCRIPTION OF THE PREFERRED EMBODIMENTS

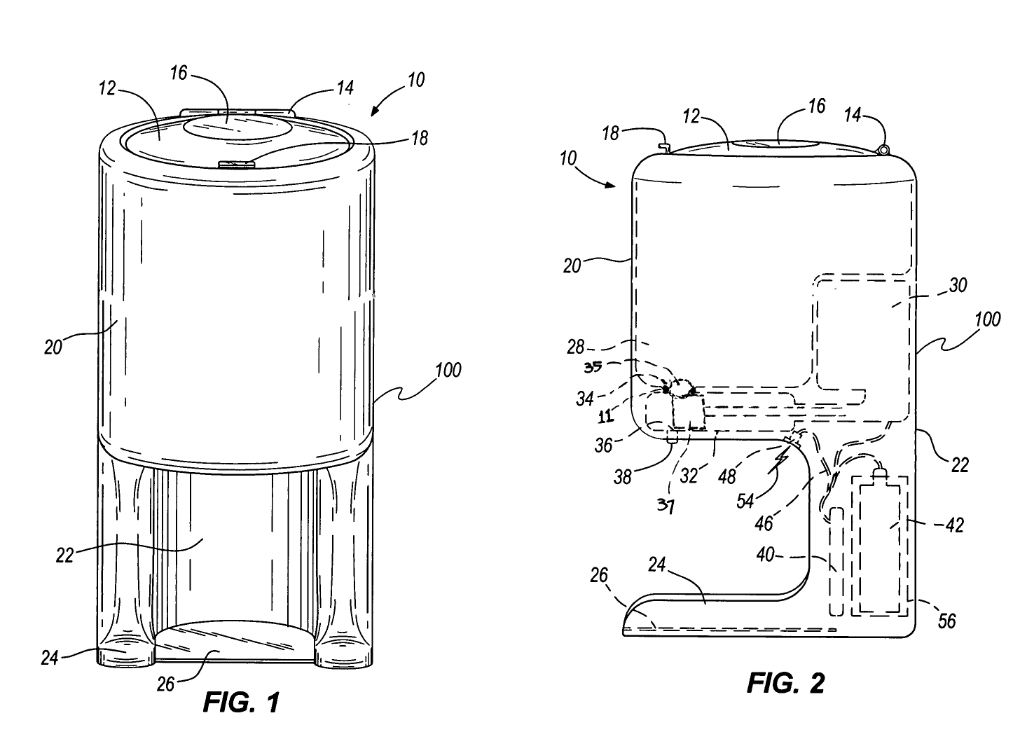

Referring now to FIGS. 1-4, and especially FIG. 1, an automatic liquid dispenser 10 is shown. A molded or formed housing 100, preferably of plastic, has an upper portion 20 with a hinged top 12 that provides access to a reservoir 28 (e.g., FIG. 2) for refilling purposes. The hinged top 12 has a locking tab 18 to prevent accidental opening and spillage of the reservoir's liquid contents. The hinged top 12 or reservoir 28 may also have a transparent window 16 for visual identification of the dispenser's contents and quantity thereof.

As shown in FIG. 2, the upper portion 20 of the housing 100 also contains the motor 30, pump 32, and detection sensor 48. The upper portion 20 of the housing 100 is elevated above a base 24 by a back section 22. The back section 22 of the housing 100 contains the batteries 42, and electronic circuitry 40. The batteries 42 are located in a battery chamber 56

As shown in FIG. 4, access to the battery chamber 56 is achieved by removal of a battery access panel 50 on the back section 22. The battery access panel 50 is removably attached to the housing 100 by a screw or locking tab to prevent accidental opening. To facilitate mounting the dispenser 10 on a wall, cut-outs 52 are provided on the back section 22 to receive a mounting bracket or mounting screws.

FIG. 2 further illustrates the arrangement and operation of the dispenser 10. Fluid present in the reservoir 28 is fed to the pump 32 via the reservoir discharge opening 34. The pump 32 includes a pump housing with an inlet coincident to the reservoir discharge opening 34, an outlet coupled to a dispensing spigot 38, a piston 37 movable between a first position and a second position in which a fluid is expelled, and a valve 36 with a naturally closed position for preventing unwanted dripping of the fluid. The motor 30 is mechanically coupled to the pump 32 to drive the piston and actuate the valve 36.

The discharge opening 34 is a hole in the bottom of reservoir 28 and is surrounded with a rubber o-ring 11. Ball bearing 35 engages the o-ring 11 to seal the reservoir 28 when piston 37 is in its resting state as shown in FIG. 2. Upon activating the dispenser 10, the piston 37 slides backward in pump 32 (toward the motor 30), and allows ball bearing 35 to drop away from o-ring 11 thereby allowing liquid present in reservoir 28 to flow into the pump 32 via the discharge opening 34. Since the ball bearing 35 is preferably smaller than the pump inlet to allow the liquid to flow into the pump, a ball bearing retaining member (not shown) in the pump inlet prevents ball bearing 35 from dropping into the pump 32 when the piston 37 slides away from the ball bearing 35.

A sensor 48 located in the upper portion of the housing 20 is positioned adjacent to the dispensing spigot 38. The sensor 48 is an infrared (IR) transceiver that transmits an IR signal 54 in the area where a user's hand or other object would be placed to receive the dispensed product. The hand or other object causes the IR signal 54 to be reflected and received at the sensor 48. The transceiver being electrically connected by a wiring harness 46 to the integrated circuit (IC) circuit board 40 initiates a state change of an IC switch, thereby actuating the motor 30 and dispensing the liquid. In alternative embodiments the sensor 48 can be sound, voice, or light activated. Additionally, a user control, such as a switch or dial, to determine the motor run time may be incorporated for the user to select the amount of liquid to be dispensed. Alternatively, the user control may cause the dispenser to operate continuously as long as an object is sensed. Additional embodiments may also include a heating element with a user control so that warm liquid may be dispensed, or a user control that converts the dispenser to a state of manual operation whereby a user would need to press a button to dispense the liquid.

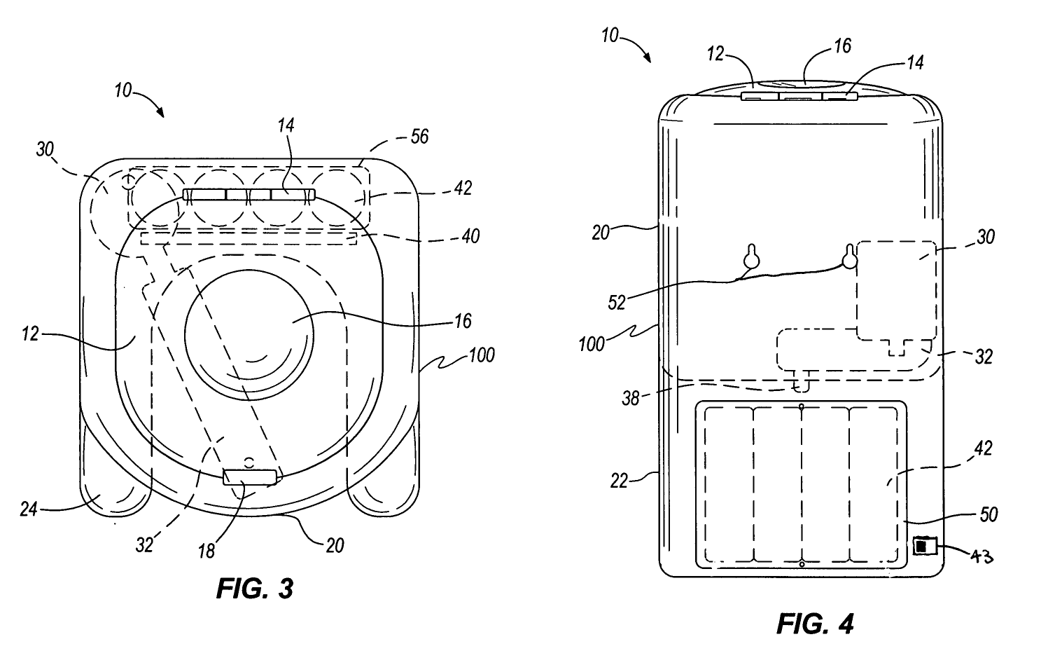

As shown in FIG. 3, the base 24 is shaped to prevent any dispensed liquid from dripping on the housing 100 or adjacent surface, and to allow easy access to the sensor 48 and the dispensing spigot 38. The shape of the legs also helps in making the product more compact by providing additional space for the user's hands or other object. The shape also makes the unit more intuitive to use. A tray 26, shown in FIG. 1, can be slidably inserted and removed in the base 24 to catch and contain any accidental or residual drippings for easy cleaning. The tray can also be removably hinged to the housing, removably plugged or snapped into the housing or otherwise removably mounted or inserted therein. The base 24 can also be adapted to accept feet, levelers, or suction cups to provide a semi-permanent installation.

As shown in FIGS. 2-4, operational power is supplied to the dispenser 10 by a battery 42 or string of batteries. The battery 42 may be disposable or rechargeable. The battery 42 is wired in series to a master on-off switch 43 that can be switched off to prevent unwanted operation of the dispenser while transporting or cleaning the unit. Operational power may also be supplied by an AC to DC adapter which is plugged into the dispenser 10 and a power outlet. Alternatively, the dispenser 10 may be hard-wired to an electrical source. If the dispenser 10 is hard-wired, a battery 42 or string of batteries may also be included as described above so the dispenser 10 will operate even if the hard-wired electrical source experiences an outage or momentary disruption.

Additionally a “try me” setting can be integrated into the master switch 43. The try me switch setting would allow for a potential purchaser to test the product at the point of sale. When the invention is set to the try me setting a potential purchaser can simulate operation of the device by activation of a light, sound, operation of internal components, or combination thereof through the detection circuitry. The try me setting is disabled by switching the unit on or off. Alternatively, a second switch may be provided that simulates momentary operation of the dispenser.

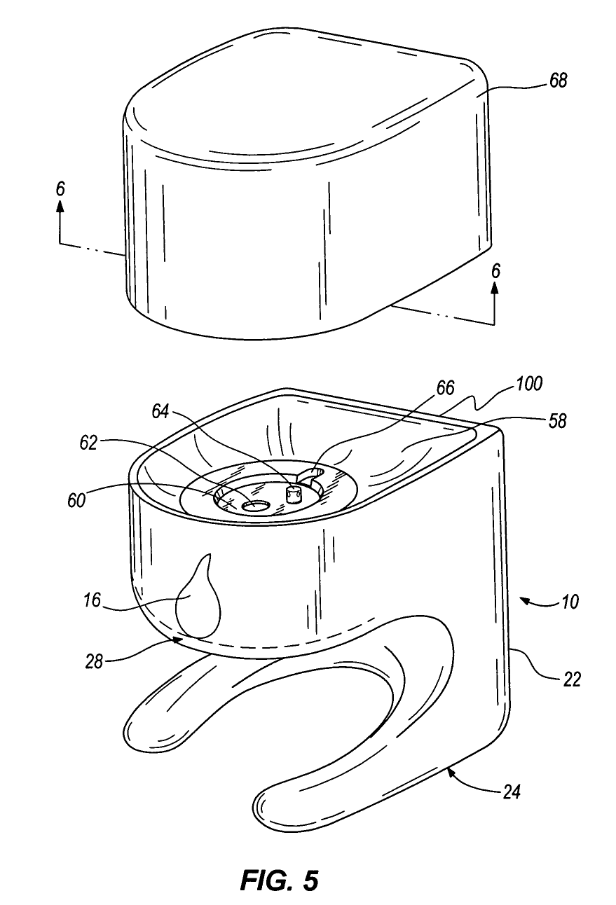

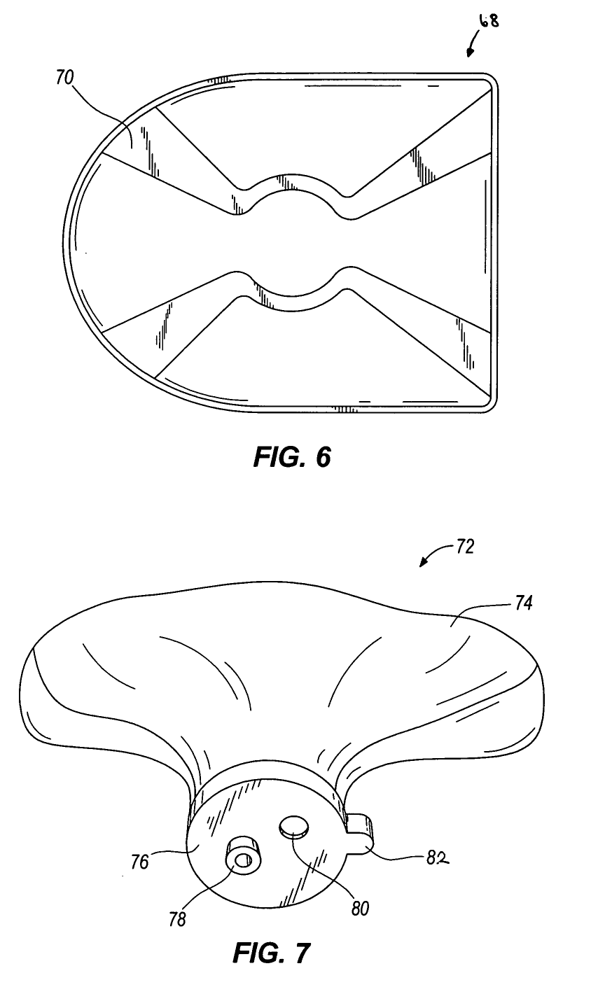

As shown in FIG. 5, a second embodiment of the automatic soap dispenser 10 has a lid 68, which is removably attached to the housing 100. The reservoir 28 of this embodiment is sealed, having a roof 58 and lid 68 defining a chamber for holding a disposable liquid cartridge, bottle, bag or other suitable container. The underside of lid 68 includes retaining elements 70 that further support and retain a disposable liquid cartridge. The disposable liquid cartridge as shown in FIG. 7 is a bag and includes a reservoir 74 and cap 76. The reservoir 74 has a predetermined volume of liquid contents and is preferably made of flexible translucent or clear plastic film. Cap 76 is also preferably formed of plastic and is fused to the reservoir 74. The cap 76 includes a liquid valve 78 which allows for the egress of the liquid contents of the reservoir 74. The valve 78 remains closed until the disposable liquid cartridge 72 is inserted into the dispenser 10. Upon removing the inserted disposable liquid cartridge 72 from the dispenser 10, the liquid valve 78 may remain open, or may be a resealable valve commonly understood by those knowledgeable in the art. The liquid cartridge cap 76 includes an air inlet 80. As liquid contents of the cartridge 72 are dispensed via the liquid valve 78, the flexible reservoir 74 collapses and contracts due to an internal vacuum. The air inlet 80 allows for air to enter the flexible reservoir 74 and replace the volume of dispensed liquid contents, thereby preventing the flexible reservoir from collapsing and blocking the valve 78.

Also as shown in FIG. 5, since the reservoir 28 is sealed by roof 58, a transparent or translucent window 16 is provided in the housing 100 for a user to visually identify the contents of the reservoir 28 and level thereof. The reservoir roof 58 has a generally concave shape and includes a detent area 60 for engaging and retaining the liquid cartridge lid 76. The detent area 60 includes a liquid inlet 62 for receiving the liquid cartridge valve 78 and allows liquid contents of the reservoir 74 of the cartridge to flow freely into the dispenser reservoir 28. An aspirator nub 64 engages the air inlet 80 of the liquid cartridge 72 and facilitates volume replacement in the reservoir 74 of the cartridge.

Switch 66 is a master on/off switch for the dispenser 10 and may be in a normally off state. An additional feature of the liquid cartridge cap 76 is finger 82. By inserting the disposable liquid cartridge 72, the cartridge cap finger 82 engages switch 66 and actuates it thereby activating the dispenser 10. Alternatively, switch 66 may be in a normally on position and the dispenser may be activated when finger 82 contacts switch 66 and internal circuitry (not shown) detects the switch state change. Therefore, the dispenser embodiment shown in FIG. 5 only accepts and is activated by liquid cartridges such as shown in FIG. 7.

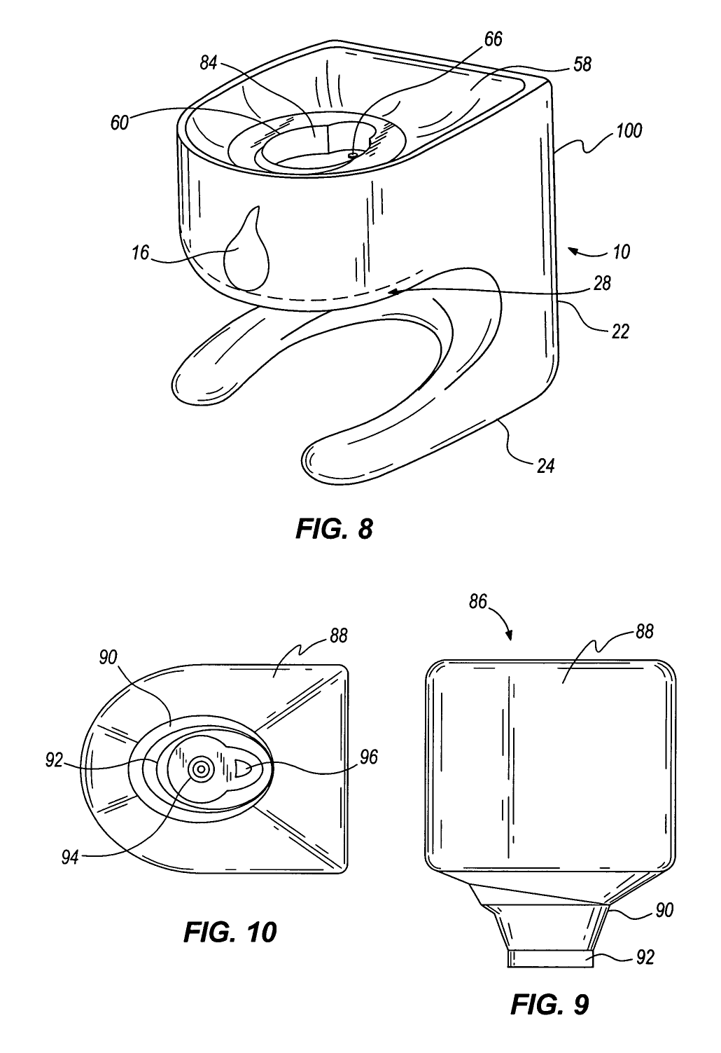

A third embodiment of an automatic liquid dispenser is shown in FIG. 8. As with the second embodiment shown in FIG. 5, the dispenser 10, as shown, has a sealed reservoir 28. The reservoir 28 has a roof 58 with a generally concave shape. The roof 58 and detent area 60 support a bottle 86, as shown in FIG. 9, with a reservoir 88 filled with liquid contents. The bottle 86, as shown in FIG. 9, also includes a shaped neck 90 and cap 92. As shown in FIG. 10, cap 92 also includes a valve 94 and a keyed area 96.

The third embodiment of the automatic liquid dispenser 10, as shown in FIG. 8, will accept and retain bottles with a unique shape, such as what is shown in FIG. 9. Bottle 86 is inserted into the dispenser 10 and engages detent area 60 and shaped recess 84. The floor of shaped recess 84 includes a switch 66 and a liquid inlet (not shown). When installed, the neck 90 of the bottle 86 nests in the shaped recess 84 and engages switch 66. The valve 94 of bottle 86 is normally closed and opens when it contacts the floor of shaped recess 84 and the liquid inlet. The liquid inlet of the dispenser may include a mechanism, such as a protrusion, positioned to meet the valve and move, flex, or break through to allow liquid contents in the reservoir 88 of the bottle 86 to exit. Air may enter through the valve 94 to replace dispensed liquid contents and prevent deformation of the bottle 86. Alternatively, an air inlet may be provided in the cap 92 of the bottle 86 that engages an aspirator nub, similar to that shown in FIG. 5, on the floor of shaped recess 84 to allow for a free-flowing amount of liquid to exit. As shown in FIG. 10, keyed area 96 may include a recess or projection that actuates switch 66 of the dispenser when bottle 86 is properly installed and retained. Alternative bottle identifying systems, such as bar codes or Radio Frequency Identification transponders, may be incorporated into keyed area 96 to function with corresponding readers in the dispenser 10 in order to activate the device.

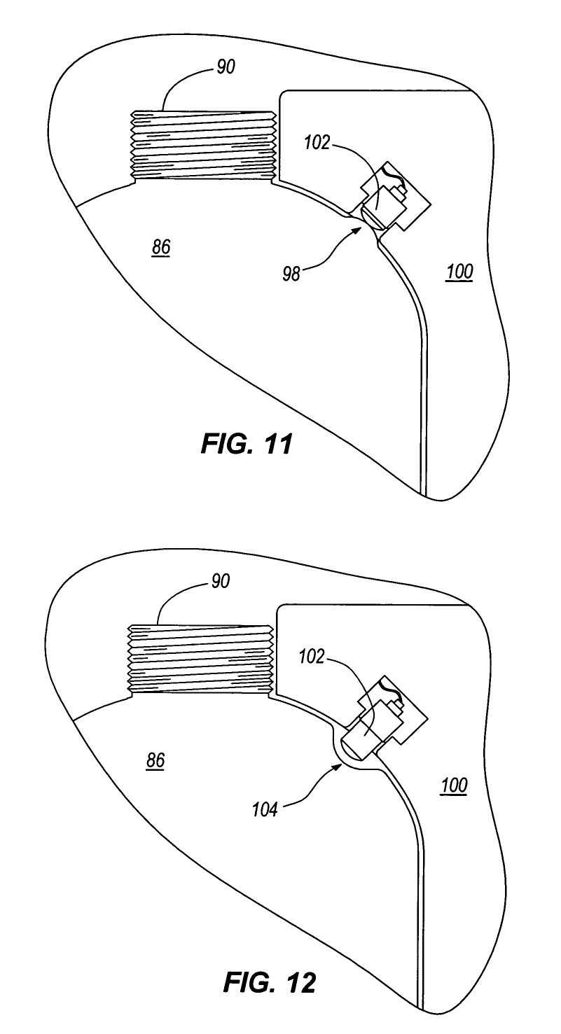

As shown in FIGS. 11 and 12, bottle 86 may incorporate a shaped area that actuates a switch 102 integrated into the housing 100 of the dispenser. Switch 102 may be mounted in the reservoir roof area 58 or detent area 60, as shown in FIGS. 5 and 8. As shown in FIG. 11, switch 102 is normally open and bottle projection 98 contacts the switch and depresses it, thereby activating the dispenser 10. In an alternative embodiment, as shown in FIG. 12, switch 102 projects into the bottle retaining area of the housing 100. Bottle 86 has a recessed area 104 that allows switch 102 to freely project into the bottle retaining area. As long as switch 102 is not depressed or actuated, the dispenser 10 will operate. If a similar shaped bottle without a recess area 104 is inserted into the dispenser 10, switch 102 will be depressed, thereby deactivating the dispenser 10. The bottle or container can be used in any suitable orientation, such as horizontal, vertical or otherwise.

Alternative embodiments may include the ability to dispense multiple fluids. A fluid switching means may be combined with a segmented housing and a dispensing system as described above, or alternatively, two or more independent dispensing systems as described above may be combined in a single housing. Additional embodiments may also include an indicating means to notify a user of a low liquid or low power condition or that the unit is in its operating mode. The indicating means can be a light, sound, or combination thereof. Alternatively, a display screen can be provided as the indicating means and can additionally display user selected settings.

While only a few, preferred embodiments of the invention have been described above, those of ordinary skill in the art will recognize that these embodiments may be modified and altered without departing from the spirit and scope of the invention. The preferred embodiments described above are to be considered in all respects as illustrative and not restrictive.

What is claimed is:

1. A dispenser for automatically dispensing liquids comprising:
a housing with a removable top and a base shaped so that the housing remains free of accidentally or residually dispensed liquid;
a reservoir enclosed in the housing for holding liquid;
a pump enclosed in the housing which is fed from the reservoir;
a motor enclosed in the housing to mechanically drive the pump;
an electrical power source;
a circuit board enclosed in the housing for receiving user inputs and for controlling the dispenser's operation;
detection circuitry linked to the circuit board and operative to sense the presence of a user's hand or an object; and
a switch linking the electrical power source to the circuit board wherein the dispenser may be activated or deactivated.

2. The dispenser of claim 1 further comprising a removable drip tray that catches and retains any accidentally or residually dispensed liquid.

3. The dispenser of claim 1 wherein the base is generally U-shaped.

4. The dispenser of claim 1 wherein the dispenser liquid comprises soap.

5. The dispenser of claim 1 wherein the detection circuitry comprises an infrared transceiver.

6. The dispenser of claim 1 further comprising a second switch for momentary simulation of the dispenser's operation.

7. The dispenser of claim 1 further comprising a user control for varying the amount of liquid dispensed.

8. The dispenser of claim 1 further comprising a heating element with user control, the heating element in communication with the reservoir for warming the reservoir's liquid contents.

9. The dispenser of claim 1 further comprising an in-reservoir liquid sensor for detecting low levels of liquid contents and an indicating means to notify a user of such sensed low levels.

10. The dispenser of claim 1 wherein the electrical power source comprises a DC power source.

11. The dispenser of claim 10 further comprising a DC power sensor for detecting low power levels and an indicating means to notify a user of such sensed low levels.

12. The dispenser of claim 1 further comprising a disposable liquid cartridge, the cartridge being keyed to operate the switch and activate the dispenser.

13. The dispenser of claim 12 wherein the cartridge is a flexible bag.

14. The dispenser of claim 12 wherein the cartridge is a bottle.

15. A dispenser for automatically dispensing liquid comprising:
a housing with a removable top and a U-shaped base so that the housing remains free of accidentally or residually dispensed liquid;
a reservoir enclosed in the housing for holding liquid;
a pump enclosed in the housing which is fed from the reservoir;
a motor enclosed in the housing to mechanically drive the pump;
a DC power source;
a circuit board enclosed in the housing for receiving user inputs and for controlling the dispenser's operation;
detection circuitry linked to the circuit board and operative to sense the presence of a user's hand or an object;
a switch linking the DC power source to the circuit board wherein the dispenser may be activated or deactivated; and
a removable drip tray that slidably inserts into the U-shaped base to catch and retain any accidentally or residually dispensed liquid.

16. A dispenser for automatically dispensing liquid comprising:
a housing with a removable top and a base shaped so that the housing remains free of accidentally or residually dispensed liquid;
a disposable liquid bag with a cap further comprising a liquid valve, an air inlet, and a finger;
a reservoir enclosed in the housing for receiving liquid from the disposable liquid bag, the reservoir having a roof with a detent area for retaining said bag;
a pump enclosed in the housing which is fed from the reservoir;
a motor enclosed in the housing to mechanically drive the pump;
a DC power source;
a circuit board enclosed in the housing for controlling the dispenser's operation;
detection circuitry linked to the circuit board and operative to sense the presence of a user's hand or other object; and
a switch linking the DC power source to the circuit board.

17. The dispenser of claim 16 further comprising a removable drip tray that catches and retains any accidentally or residually dispensed liquid.

18. The dispenser of claim 16 wherein the detection circuitry comprises an infrared transceiver.

19. The dispenser of claim 16 wherein the detent area further comprises a liquid inlet in communication with the reservoir, and an aspirator nub for replacement of the liquid bag contents with air.

20. The dispenser of claim 16 wherein the switch is located in the detent area, the switch actuatable by the finger of the bag cap to activate the dispenser.

21. A dispenser for automatically dispensing liquid comprising:
a housing with a base shaped so that the housing remains free of accidentally or residually dispensed liquid;
a disposable drop-in liquid bottle with a shaped neck and a cap further comprising a liquid valve and an air inlet;
a reservoir enclosed in the housing for receiving liquid from the disposable drop-in liquid bottle, the reservoir having a roof with a detent area for supporting the bottle, the detent area having a shaped recess for receiving the bottle shaped neck;
a pump enclosed in the housing which is fed from the reservoir;
a motor enclosed in the housing to mechanically drive the pump;
a DC power source;
a circuit board enclosed in the housing for controlling the dispenser's operation;
detection circuitry linked to the circuit board and operative to sense the presence of a user's hand or other object; and
a switch linking the DC power source to the circuit board.

22. The dispenser of claim 21 further comprising a removable drip tray that catches and retains any accidentally or residually dispensed liquid.

23. The dispenser of claim 21 wherein the detection circuitry comprises an infrared transceiver.

24. The dispenser of claim 21 wherein the switch is actuatable by the bottle neck or cap thereby activating the dispenser.

25. The dispenser of claim 21 wherein the bottle further comprises a recess or projection.

26. The dispenser of claim 25 wherein the switch is actuatable by the bottle recess or projection thereby activating the dispenser.
